(19) United States
(12) Patent Application Publication
(10) Pub. No.: US 2016/0100534 A1
(43) Pub. Date: Apr. 14, 2016

(54) WATER SUPPLY CONTAINER FOR PLANT CULTIVATION

(71) Applicant: Wen-Fu CHANG, New Taipei City (TW)

(72) Inventor: Wen-Fu CHANG, New Taipei City (TW)

(21) Appl. No.: 14/510,979

(22) Filed: Oct. 9, 2014

(51) Int. Cl. A01G 27/00; B65D 1/34

(52) U.S. Cl. CPC A01G 27/00; B65D 1/34

(57) ABSTRACT

A water supply container for plant cultivation is disclosed, which comprises a water-holding tray, wherein an end of the water-holding tray is configured with a positioning space, and a positioning pillar is formed in upward protrusion from the bottom of the positioning space; moreover, the positioning space includes a wall face formed around the periphery of the positioning pillar, in which the wall face corresponding to the middle section of the positioning pillar is configured with a screw thread. In addition, the positioning pillar can be further combined with a water supply bottle fixed to the positioning space of the water-holding tray, and on the outer wall face of the positioning pillar there includes at least a water supply channel so that the liquid flowing down from the water supply bottle enters into the water-holding tray along the water supply channel.

### BACKGROUND OF THE INVENTION

1. Field of the Invention

The present application generally concerns a water supply container for plant cultivation; in particular, it relates to a container featuring convenient water supply for plant cultivation.

2. Description of Related Art

Typically, a common prior art flowerpot may become very dry in about 2-3 sunny days, so soil in the flowerpot will harden and fissures may appear in soil near the rim of the flowerpot. Consequently, when watering the flowerpot, 80% of water may directly flow through these fissures to the bottom and exit by way of drain holes, while only about a depth of 5 centimeters in the soil held by the flowerpot can actually retain water, so the soil close to the central bottom of the flowerpot that really needs to be irrigated is still very hard and lacks of water, causing the plant to grow in a poor environment, and thus that most plants may wither and fade due to this defects. Some flowerpots utilize a sort of base plate to solve the aforementioned problem; however, during rain seasons, the bottom of such flowerpots would be kept in an extremely wet condition so the root of the plant therein may rotten and die.

So far, to address the issue as previously set forth is to manually check out whether the water held in the flowerpot is sufficient or excessive; but, in this way, it would require significant time and efforts to take good care of it, and for a flower farmer needing to look after perhaps hundreds of plantation pots, such a large consumption of manpower and time would lead to relatively low efficiency.

Therefore, it would be an optimal solution if a water supply container allowing convenient and practical operations as well as limitation on water supply amount in order to fulfill such present demands can be disclosed.

### SUMMARY OF THE INVENTION

The present invention is to provide a water supply container for plant cultivation which features simple and practical operations and allows limitation on water supply amount.

The water supply container for plant cultivation according to the present invention comprises: a water-holding tray, wherein an end of the water-holding tray is configured with a holding space, and the other end thereof a positioning space, and a positioning pillar is formed in upward protrusion from the bottom of the positioning space, and on the outer wall face of the positioning pillar there includes at least a water supply channel.

In a preferred embodiment, on the positioning space there includes a wall face.

In a preferred embodiment, it further comprises a water supply bottle which is combined onto the positioning pillar such that the top end of the water supply bottle can be fixed to the positioning space of the water-holding tray.

In a preferred embodiment, it further comprises a water supply tube which is combined onto the positioning pillar such that the top end of the water supply tube can be fixed to the positioning space of the water-holding tray, while the other end thereof connected to a water supply source.

In a preferred embodiment, the positioning pillar is of a top-narrow-bottom-wide structure.

In a preferred embodiment, the top end of the positioning pillar shrinks inward to form a neck portion.

In a preferred embodiment, the number of neck portions in the positioning pillar is one or more.

In a preferred embodiment, there are two or more positioning spaces.

In a preferred embodiment, the positioning pillar of the water-holding tray is of a hollow structure, and the water supply channel of the positioning pillar recesses toward the hollow structure such that a positioning flange protrudes relatively in the hollow structure so as to facilitate up-down sleeve coupling of two water-holding trays.

In a preferred embodiment, the respective holding space in the two water-holding trays can be connected by means of a connection tube such that the irrigation liquid flows into the other water-holding tray through the connection tube.

### BRIEF DESCRIPTION OF THE DRAWINGS

FIG. 1 shows a stereo structural view of the water supply container for plant cultivation according to the present invention;

FIG. 2 shows a cross-section structural view of the water supply container for plant cultivation according to the present invention;

FIG. 3A shows a structural view of another embodiment for a positioning pillar in the water supply container for plant cultivation according to the present invention;

FIG. 3B shows a structural view of yet another embodiment for a positioning pillar in the water supply container for plant cultivation according to the present invention;

FIG. 4 shows a view of an embodiment of the water supply container for plant cultivation according to the present invention;

FIG. 5 shows a view of another embodiment of the water supply container for plant cultivation according to the present invention;

FIG. 6 shows a view of yet another embodiment of the water supply container for plant cultivation according to the present invention; and

FIG. 7 shows a view of still another embodiment of the water supply container for plant cultivation according to the present invention.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

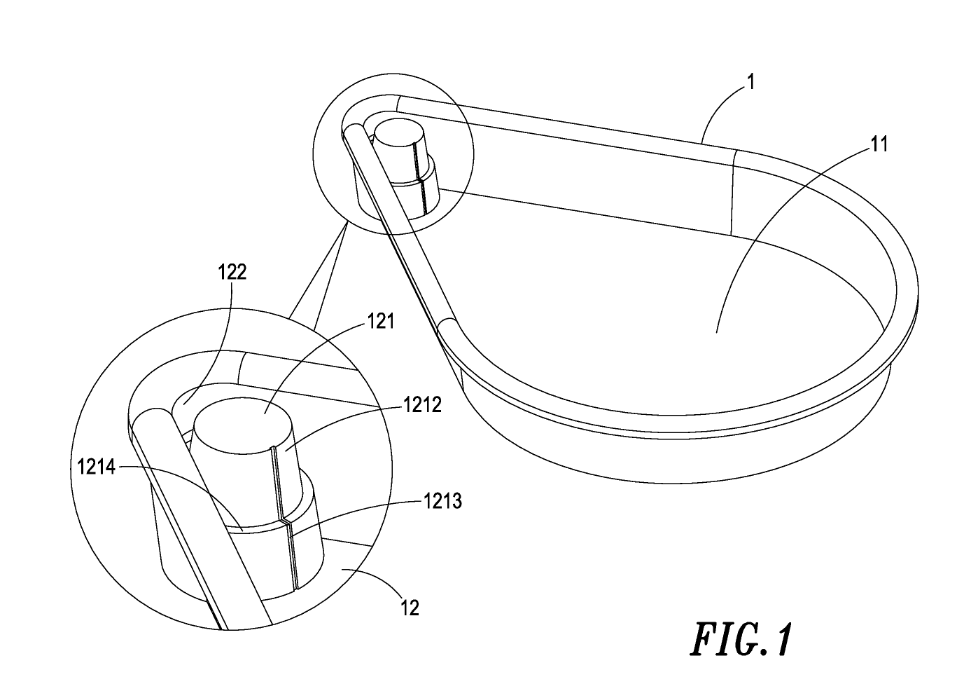

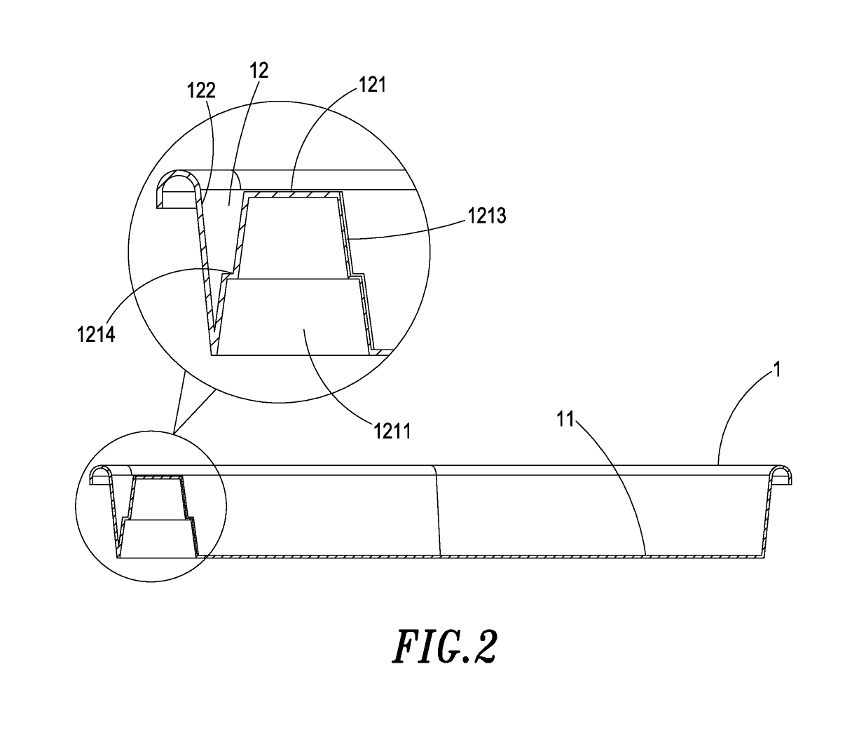

Refer now to FIGS. 1 and 2, wherein a stereo structural view as well as a cross-section structural view of the water supply container for plant cultivation according to the present invention is respectively shown. From the Figures it can be noticed that the illustrated water supply container for plant cultivation comprises a water-holding tray 1, wherein an end of the water-holding tray 1 is configured with a holding space 11, while the other end thereof a positioning space 12; a positioning pillar 121 is formed in upward protrusion from the bottom of the positioning space 12, and the positioning space 12 includes a wall face 122.

Moreover, on the outer wall face 1212 of the positioning pillar 121 there includes at least a water supply channel 1213 installed solely on the surface of the positioning pillar 121, rather than penetrating the positioning pillar 121. A roughly middle part of the positioning pillar 121 shrinks inward to form a neck portion 1214, and since the positioning pillar 121 is configured to be further connected to a water supply bottle (e.g., a PET bottle) or a water supply tube, such a neck portion 1214 facilitates a top water outlet of the water supply bottle or water supply tube to be conveniently fixed onto the positioning pillar 121, and the tapered design of the positioning pillar 121 allows a stable and tight sleeve joint of the water supply bottle or water supply tube onto the positioning pillar 121.

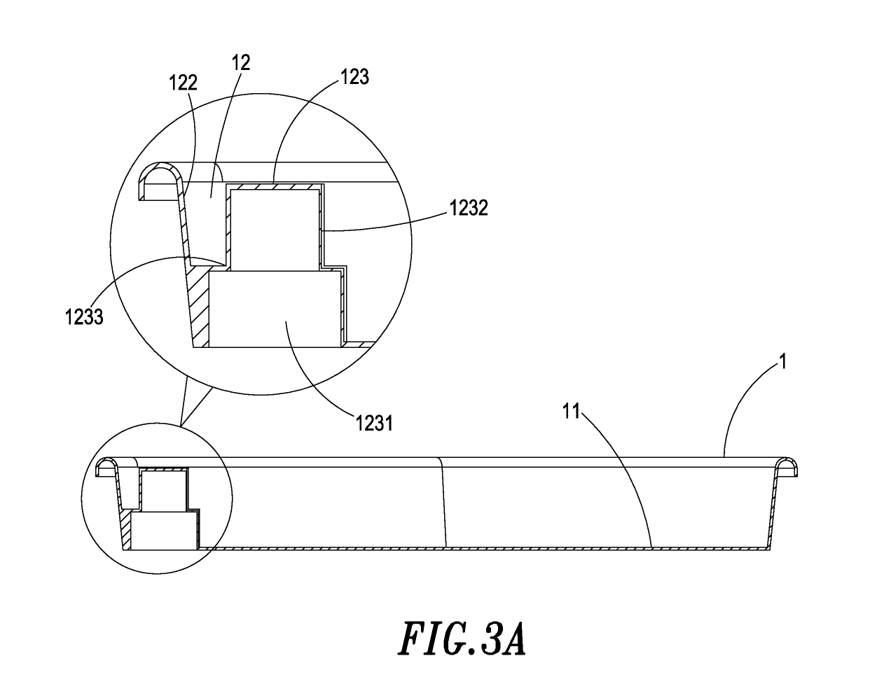

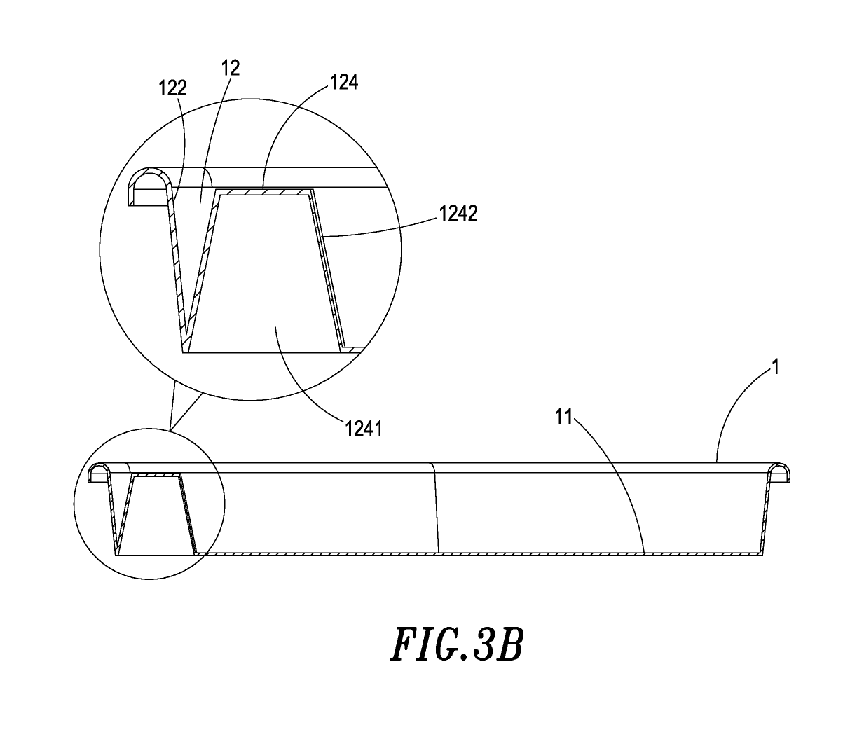

In addition to the up-narrow-bottom-wide tapered structure as shown in FIGS. 1 and 2, the top end of the positioning pillar 123 can also shrink inward to form a neck portion 1233, as shown in FIG. 3A. Here the interior of the positioning pillar 123 is of a hollow structure 1231, and a water supply channel 1232 is formed on the surface of the positioning pillar 123. However, by comparing with the structure shown in FIGS. 1 and 2, it can be seen that the difference there between is the lateral side of the positioning pillar 123 is not tilted, but a vertical surface. Although a neck portion is configured in the structure shown as FIG. 3A, it can be optionally omitted as described in FIG. 3B, wherein the interior of the positioning pillar 124 is of a hollow structure 1241 and the surface thereof also includes a water supply channel 1242; in addition, the positioning pillar 124 is of a tapered structure.

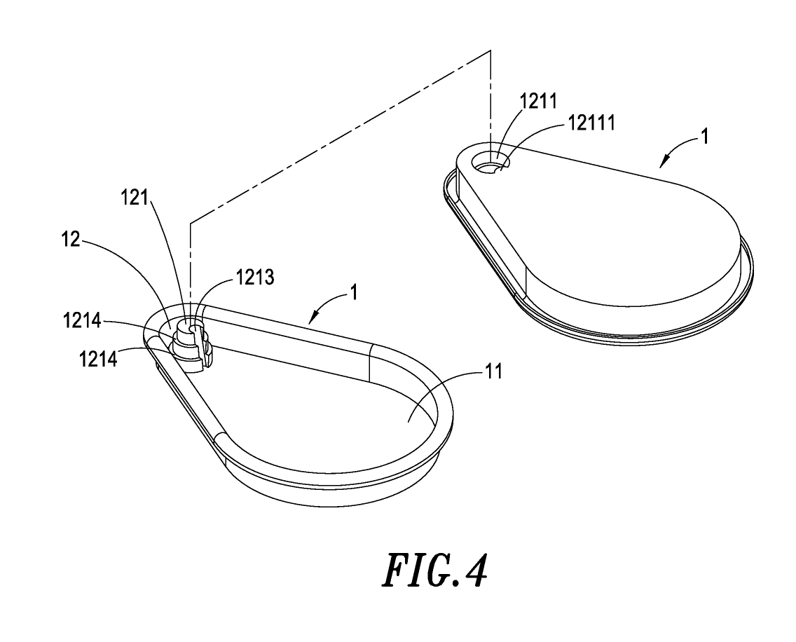

The interior of the aforementioned positioning pillar 121, 123, 124 can be of a hollow structure 1211, 1231, 1241, respectively, thereby allowing multiple water-holding trays to be top-down placed in stack so as to achieve convenient accommodation and hand-carry features. Following this, refer next to FIG. 4, wherein the water supply channel 1213 of the positioning pillar 121 recesses toward the hollow structure 1211, and a positioning flange 12111 protrudes relatively to the inside of the hollow structure 1211. Hence, when up-down sleeve coupling two water-holding trays 1 in stack, the positioning pillar 121 of the lower water-holding tray 1 can insert into the hollow structure 1211 of the upper water-holding tray 1, and the water supply channel 1213 in the positioning pillar 121 of the lower water-holding tray 1 can embed into the positioning flange 12111 in the hollow structure 1211 of the upper water-holding tray 1, such that the upper and lower water-holding trays 1 can be firmly stacked up rather than rotating about the positioning pillar 121 as a supporting point. Moreover, the number of the neck portion 1214 may be one or more without limitation.

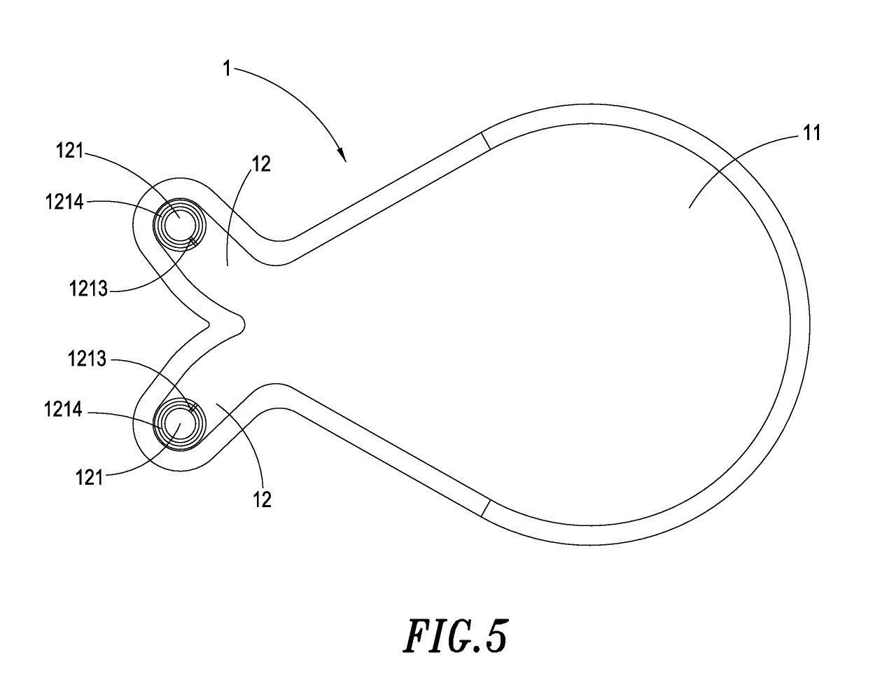

FIG. 5 shows a view of another embodiment of the present invention. The difference from FIG. 1 lies in that two or more positioning spaces 12 can be configured on one end of the water-holding tray 1, with each positioning space 12 having a positioning pillar 121, and a water supply channel 1213 as well as a neck portion 1214 being installed on the positioning pillar 121; other parts thereof are identical to those in FIG. 1, so herein omitted for brevity.

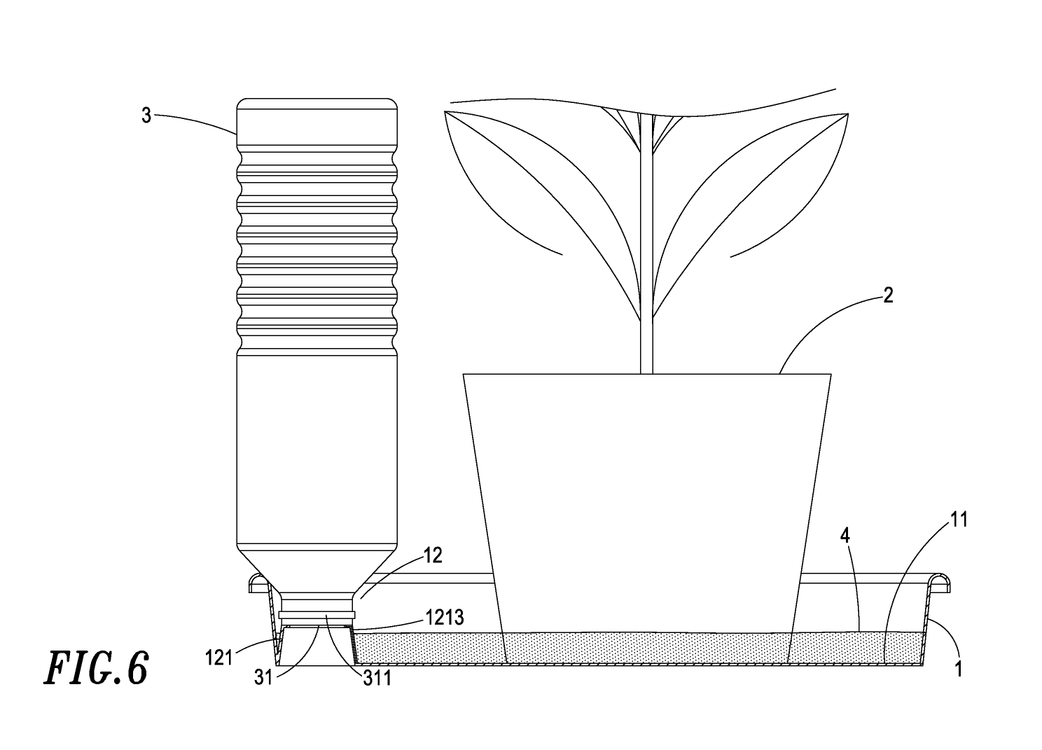

As shown in FIG. 6, when using the water supply container for plant cultivation, placing a plant pot 2 onto the water-holding tray 1, then inserting a water supply bottle 3 onto the positioning pillar 121 and rotating the water supply bottle 3 on the positioning pillar 121, the screw thread 311 on the outer side of the top water outlet 31 of the water supply bottle 3 can screw fit into the screw thread 1221, 1222 on the wall face 122 such that the irrigation liquid held in the water supply bottle 3 flows out into the positioning space 12 by way of the water supply channel 1213. And since the positioning space 12 is directly connected to the water-holding tray 11, the irrigation liquid 4 flows into the water-holding tray 11. As the water level of the irrigation liquid 4 in the water-holding tray 11 rises up and approaches the top water outlet 31 of the water supply bottle 3, the top water outlet 31 of the water supply bottle 3 will stop providing the irrigation liquid 4. However, as time passes, the irrigation liquid 4 in the water-holding tray 11 gradually decreases, so the water level descends. Under such circumstances, the irrigation liquid 4 will flow out from the top water outlet 31 of the water supply bottle 3 such that the water level of the irrigation liquid 4 in the water-holding tray 11 goes up and gets close to the top water outlet 31 of the water supply bottle 3 once again, thus then stopping the provision of the irrigation liquid 4 one more time.

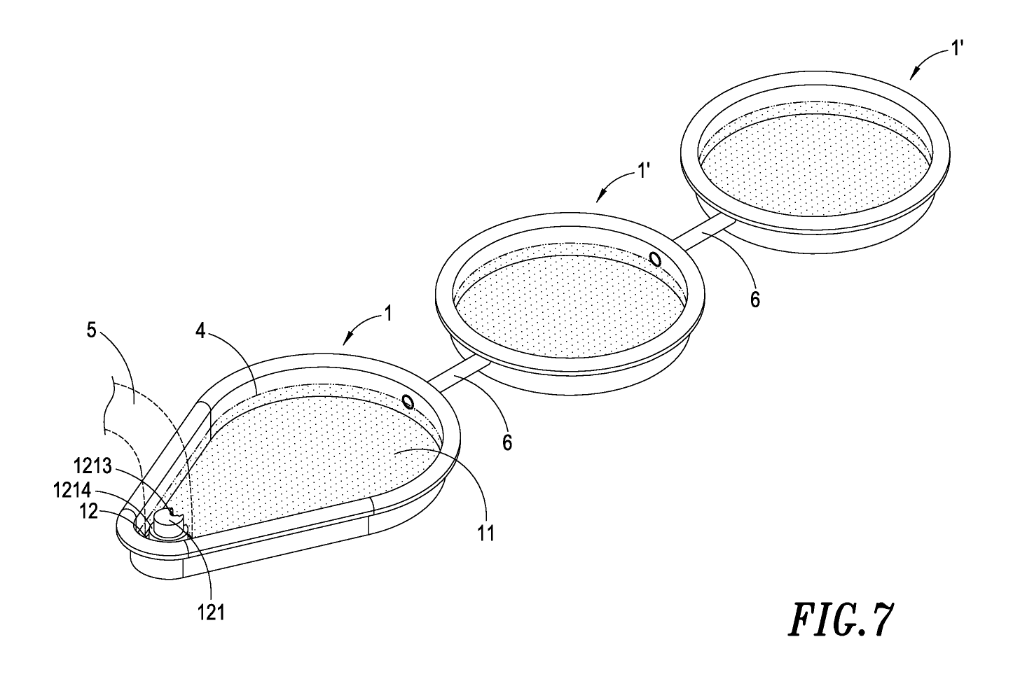

Referring next to FIG. 7, another embodiment of the water supply container for plant cultivation according to the present invention is shown, wherein the water-holding tray 1 can be serially coupled to several other water-holding trays 1′ by means of a connection tube 6 and a water supply tube 5 can be sleeve connected to the positioning pillar 121 of the water-holding tray 1, while the other end of the water supply tube 5 connected to a water tank, a faucet or other water supply sources. Upon providing liquid into the holding space 11 of the water-holding tray 1 connected with the water supply tube 5, the provided liquid flows into other water-holding trays 1′ by way of the connection tube 6. Other operations are identical to the counterparts illustrated in FIG. 6 and the structure thereof is equivalent to the FIG. 1, thus herein omitted for brevity.

Compared with other conventional technologies, the water supply container for plant cultivation according to the present invention provides the following advantages:

the present invention utilizes a simple, useful water-holding container capable of restricting water supply amount, so the user needs not to check out whether the dispatched water is insufficient or excessive everyday, thereby saving the user's time and efforts to effectively improve the efficiency in manpower and time.

By way of the aforementioned detailed descriptions for the preferred embodiments according to the present invention, it is intended to better illustrate the characters and spirit of the present invention rather than restricting the scope of the present invention to the preferred embodiments disclosed in the previous texts. Contrarily, the objective is to encompass all changes and effectively equivalent arrangements within the scope of the present invention as delineated in the following claims of the present application.

What is claimed is:

1. A water supply container for plant cultivation, comprising:
a water-holding tray, wherein an end of the water-holding tray is configured with a holding space, and the other end thereof a positioning space, a positioning pillar is formed in upward protrusion from the bottom of the positioning space, and on the outer wall face of the positioning pillar there includes at least a water supply channel.

2. The water supply container for plant cultivation according to claim 1, wherein on the positioning space there includes a wall face.

3. The water supply container for plant cultivation according to claim 1, further comprising a water supply bottle which is combined onto the positioning pillar such that the top end of the water supply bottle can be fixed to the positioning space of the water-holding tray.

4. The water supply container for plant cultivation according to claim 1, further comprising a water supply tube which is combined onto the positioning pillar such that the top end of the water supply tube can be fixed to the positioning space of the water-holding tray, while the other end thereof connected to a water supply source.

5. The water supply container for plant cultivation according to claim 1, wherein the positioning pillar is of a top-narrow-bottom-wide structure.

6. The water supply container for plant cultivation according to claim 5, wherein the top end of the positioning pillar shrinks inward to form a neck portion.

7. The water supply container for plant cultivation according to claim 6, wherein the number of neck portions in the positioning pillar is one or more.

8. The water supply container for plant cultivation according to claim 1, wherein there are two or more positioning spaces.

9. The water supply container for plant cultivation according to claim 1, wherein the positioning pillar of the water-holding tray is of a hollow structure, and the water supply channel of the positioning pillar recesses toward the hollow structure such that a positioning flange protrudes relatively in the hollow structure so as to facilitate up-down sleeve coupling of two water-holding trays.

10. The water supply container for plant cultivation according to claim 1, wherein the respective holding space in the two water-holding trays can be serially connected by means of a connection tube such that the irrigation liquid can flow into the other water-holding tray through the connection tube.
